(19) United States
(12) Patent Application Publication
(10) Pub. No.: US 2016/0050279 A1
(43) Pub. Date: Feb. 18, 2016

(54) METHOD FOR MANAGING IoT DEVICES AND ANALYZING SERVICE OF BIG DATA

(71) Applicant: mFrontiers, LLC, Libertyville, IL (US)

(72) Inventor: Daniel PAHNG, Green Oaks, IL (US)

(21) Appl. No.: 14/803,443

(22) Filed: Jul. 20, 2015

Related U.S. Application Data
(60) Provisional application No. 62/026,216, filed on Jul. 18, 2014.

(51) Int. Cl. H04L 29/08; G06Q 30/06; H04L 12/26

(52) U.S. Cl. CPC H04L 67/12; H04L 43/065; G06Q 30/0613

(57) ABSTRACT

Disclosed is a method for operating an IoT big data analysis service using a computer system connected to at least one mFinity IoT device through the Internet, the method comprising: determining whether data transferred through the internet using an mFinity IoT web server from the mFinity IoT device is a known source point; and storing the data in an mFinity big data cloud if the data is determined to be a known source point, wherein a Hadoop server, which is a big data analysis system analyzes the stored data and produces a big data analysis report.

### BACKGROUND

1. Field

The present invention relates to a method and a system for operating an IoT (Internet of Things) big data analysis service and a computer readable medium on which the method is written. More particularly, the present invention relates to a method and a system for operating IoT big data analysis service wherein data transferred from IoT devices is stored as big data and the stored big data can be analyzed, and a computer readable medium on which the method is written.

2. Description of the Related Art

The internet comprises a huge number of computers that are globally connected to each other through communication links.

The connected computers exchange information using various services, e.g., e-mail, gopher and the World Wide Web. The World Wide Web allows server computer systems (e.g., web servers or websites) to send graphical webpages of information to remote client computer systems.

These remote client computer systems are able to display various webpages that are transferred from server computers.

Recently, wireless communication networks such as mobile communication networks like 2G, 3G, 4G, 5G and LTE, Wi-Fi networks, Bluetooth communication networks, cellular communication networks, CDMA networks, LTE networks, Ethernet, WiMAX (Worldwide Interoperability for Microwave Access), local area network (LAN), wide area network (WAN), RF network, infrared network and optical communication network rapidly develop and various systems are developed using the wireless communication networks.

Generally, the Internet of Things (IoT) is a concept that means that communication function is added to various devices capable of fulfilling various functions, e.g., refrigerators, washing machines, televisions and smart devices, such that the devices intelligently collects information on surroundings and communicates the collected information on the Internet. That is, the IoT means devices or appliances or communication networks that are capable of sensing and communicating and are configured to provide collected information for or exchange information with other devices.

### SUMMARY

Huge amounts of big data have been collected with regard to conventional IoT but are likely to be easily ignored or discarded by individuals or businesses since the data have a wide variety of types and analysis tools for analyzing the data are not developed.

An aspect of the present invention is to provide a method and a system for operating an IoT (Internet of Things) big data analysis service and a computer readable medium on which the method is written, from which all parties involved benefit, wherein IoT devices are registered to create data in the form of mFinity platform, known data is stored using an mFinity web server, the stored data is made analyzable by Hadoop servers such that big data and analysis reports using big data can be purchased by or sold to individuals or businesses, and a writer of preliminary analysis reports for producing analysis reports makes a profit. However, the task is illustrative only and the present invention is not limited thereto.

A method for operating an IoT big data analysis service according to an aspect of the present invention may include: determining whether data transferred through the internet using an mFinity IoT web server from the mFinity IoT device is a known source point; and storing the data in an mFinity big data cloud if the data is determined to be a known source point, and a Hadoop server, which is a big data analysis system, may analyze the stored data and produce a big data analysis report.

Furthermore, if the mFinity IoT device is capable of directly connecting to the Internet, the mFinity IoT device may connect to the Internet and transfer data in the form of mFinity to the mFinity big data cloud. If the mFinity IoT device is incapable of directly connecting to the internet, the mFinity IoT device may indirectly connect to the Internet via an mFinity client terminal, which is capable of connecting to the Internet, and transfer data in the form of mFinity to the mFinity big data cloud.

Furthermore, a virtual big data marketplace where big data in the form of a stored mFinity platform can be purchased or sold may be provided on the the mFinity big data cloud, and the big data purchased or sold at the big data marketplace may be transferred to at least one of an mFinity client terminal, an individual customer's terminal and a business customer's computer.

Furthermore, a virtual analysis report marketplace where information on analyzed big data analysis report can be purchased or sold may be provided on the mFinity big data cloud, and the information on the big data analysis report purchased or sold at the analysis report marketplace may be transferred to at least one of an mFinity client terminal, an individual customer's terminal and a business customer's computer.

Furthermore, the information on big data analysis report may include information on a preliminary analysis report whose results vary according to analysis time or period, and, when a third party analyzes big data using the information on preliminary analysis report, a writer who uploaded the information on preliminary analysis report to the analysis report marketplace may charge fees for the information.

Furthermore, the mFinity IoT device may be assigned a unique code using SDK that is downloaded and installed, and then the mFinity IoT device may be registered and the mFinity IoT device may generate IoT data in the form of mFinity and then transfer the IoT data to the mFinity IoT web server.

Furthermore, if the mFinity IoT device is connected to the internet, the mFinity IoT device may transfer data in the form of mFinity to the mFinity IoT web server, and, if the mFinity IoT device is not connected to the internet, the mFinity IoT device may store the created IoT data within the mFinity IoT device such that the data may be transferred to the mFinity IoT web server later.

Furthermore, the mFinity big data cloud may include: the mFinity IoT web server, which functions as a gateway, the Hadoop server, which collects data from distributed data sources, and an mFinity big data administrator console, which manages the Hadoop server.

Furthermore, the mFinity big data administrator console may include a graphic user interface screen, and the graphic user interface screen may capture required information and create a configuration file system for each Hadoop server related to data input/output.

Furthermore, the graphic user interface screen may includes a circular control component, and the circular control component may include: an outer circle that is divided into segmented arcs, which are equivalent to duration, a handler that slides the segmented arcs to control the duration and an inner circle that is highlighted when the segmented arcs are selected and includes a circulator slider for controlling the value of the segmented arcs.

Furthermore, a personal IoT big data of a person who purchased an mFinity IoT ready device or an mFinity IoT device may be stored as a personal version in a personal big data place of the mFinity big data cloud, and business's IoT big data that has accumulated for products may be stored as an enterprise version in a business big data place of the mFinity big data cloud.

Furthermore, a system for operating an IoT big data analysis service according to another aspect of the present invention may include: a control unit that is programmed to determine whether data transferred through the internet using an mFinity IoT web server from the mFinity IoT device is a known source point; and to store the data in an mFinity big data cloud if the data is determined to be a known source point, and a Hadoop server, which is a big data analysis system, may analyze the stored data and produce a big data analysis report.

Furthermore, a computer readable medium on which a method for operating an IoT big data analysis service according to yet another aspect of the present invention may include: determining whether data transferred through the internet using an mFinity IoT web server from the mFinity IoT device is a known source point; and storing the data in an mFinity big data cloud if the data is determined to be a known source point, and a Hadoop server, which is a big data analysis system, may analyze the stored data and produce a big data analysis report.

### BRIEF DESCRIPTION OF THE DRAWINGS

FIG. 1 is a schematic view for understanding an mFinity platform according to an embodiment of the present invention.

FIG. 2 is a schematic diagram of a system for operating an IoT analysis service according to an embodiment of the present invention.

FIG. 3 is a detailed diagram of an mFinity big data cloud of the system for operating an IoT analysis service of FIG. 2.

FIG. 4 is a schematic diagram illustrating a relationship among an operator of an IoT analysis service according to an embodiment of the present invention, an mFinity client, an individual customer/business and a writer of a preliminary report.

FIG. 5 is a flowchart sequentially illustrating a method for operating an IoT analysis service according to an embodiment of the present invention.

FIGS. 6 and 7 show graphic user interface screens provided by an IoT analysis service according to an embodiment of the present invention.

### DETAILED DESCRIPTION

Hereinafter, embodiments of the present disclosure will be described in detail with reference to the accompanying drawings.

The embodiments of the present disclosure are provided to more fully describe the present disclosure to those of ordinary skill in the art. The following embodiments may be modified to various types and the scope of the present disclosure is not limited to the following embodiments. Rather, these embodiments are provided so that this disclosure will be thorough and complete, and will fully convey the spirit of the present disclosure to those skilled in the art. Also, in the figures, a thickness or dimension of each of layers is exaggerated for clarity of illustration.

The terms used herein are for illustrative purposes of the present disclosure only and should not be construed to limit the meaning or the scope of the present disclosure. As used in this specification, a singular form may, unless definitely indicating a particular case in terms of the context, include a plural form. Also, the expressions “comprise” and/or “comprising” used in this specification neither define the mentioned shapes, numbers, steps, operations, members, elements, and/or groups of these, nor exclude the presence or addition of one or more other different shapes, numbers, steps, operations, members, elements, and/or groups of these, or addition of these.

Hereinafter, embodiments of the present disclosure will be described with reference to the attached drawings that schematically illustrate the ideal embodiments of the present disclosure. In the drawings, for example, according to the manufacturing technology and/or tolerance, the modification of the illustrated shape may be expected. Thus, the embodiments of the present disclosure must not be interpreted to be limited by a particular shape that is illustrated in the drawings and must include a change in the shape occurring, for example, during manufacturing.

Hereinafter, a method and a system for operating an IoT big data analysis service and a computer readable medium on which the method is written will be described in detail with reference to the accompanying drawings.

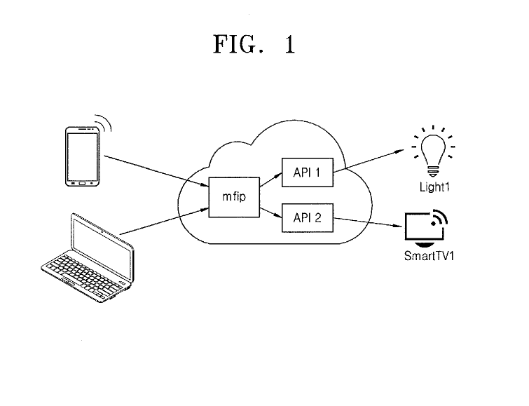

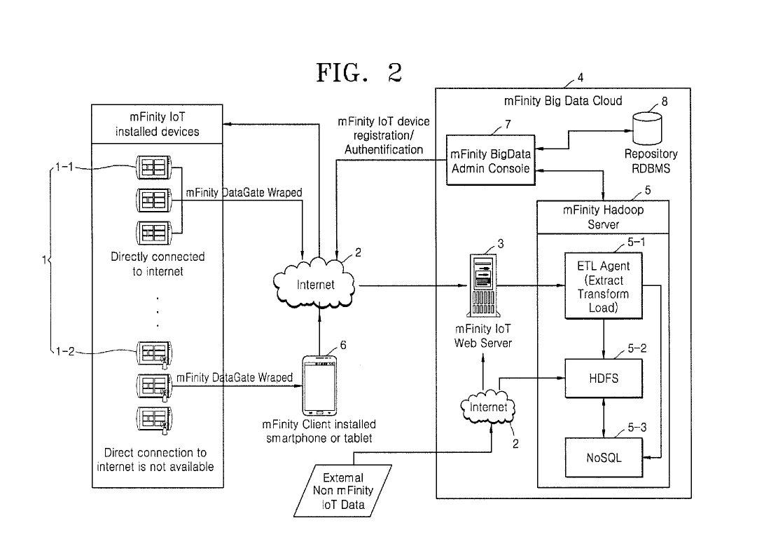

FIG. 1 is a schematic diagram of a system for operating an IoT big data analysis service according to an embodiment of the present invention, and FIG. 2 is a detailed diagram of an mFinity big data cloud of the system for operating an IoT big data analysis service of FIG. 1.

Here, an mFinity may be an EMMP (enterprise mobility management platform) and IoT platform. The mFinity platform helps prepare for the current confusing state wherein IoT platforms are not unified but mixed.

That is, although various products are on the IoT market now, no standard exists. For example, it would be said that a cellphone produced by company “A” cannot be used to control an air conditioner produced by company “B”. Therefore, customers have limited choices regarding products or reluctantly give up syncing between the devices.

As shown in FIG. 1, an open type protocol titled “mfip” (mFinityIoT Protocol) is provided additionally to the current mFinity platform such that users may use this protocol to send orders to a device registered under their names.

APIs that control each product are present on the server side and are directly integrated into an mFinity Platform (cloud side). The mfip is also on the server side and, when a control request is made by a client, splits services to an API for the item to be controlled.

As shown in FIG. 1, using javascript that is capable of calling this, services may be developed on web clients. Without having to study each of complex APIs that are explained with regard to respective products, users will be able to easily develop services, e.g., as follows only if they have an understanding of the mfip.

```
    <script  type=“text/javascript”  src=“http://server.com/
mfipRequest.js”></script>
    <script type=“text/javascript”>
    varmfip = new mfipObj( );
    mfip.turnOn(“SmartTV1”);
    mfip.turnOff(“Light1”);
    </script>
```

For example, as explained above, items that can be set by mfip are estimated to be “Turn On”, “Turn Off” and “Set Configuration”, and it is expected that automatic conditional control will be possible in the future by mounting rule engine which is capable of controlling other devices using sensor information of each device.

That is, for example, if the current temperature, collected by a temperature sensor on a boiler, is at least 70° F., a light bulb may be turned off (action 1: mfip.turnOff (“Light1”)) and the refrigerator may maintain lower temperatures (action 2: mfip.setConfiguration (“Refrigerator1”, “Temp=20”)). Therefore, using these mFinity platforms, all information and control regarding current IoT devices may be integrated.

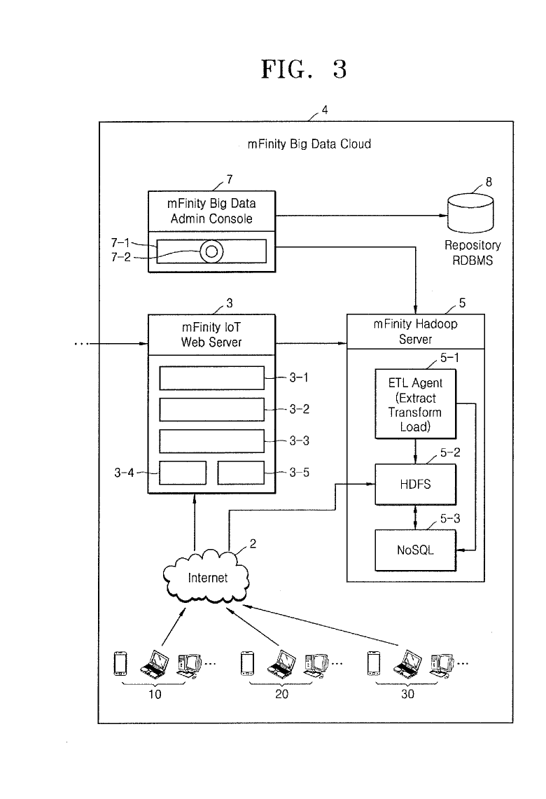

Furthermore, as shown in FIGS. 2 and 3, a system for operating an IoT big data analysis service according to an embodiment of the present invention may include an mFinity IoT device 1, an mFinity client terminal 6, and an mFinity big data cloud 4 that is connected to the mFinity IoT device 1 through the internet 2.

Here, the mFinity IoT device 1 may be any IoT device that is capable of collecting signals or information regarding surroundings using various sensors (not shown), converting the collected signals or information to mFinity platforms, and transferring the mFinity platforms to the mFinity big data cloud 4 through the internet 2. The mFinity IoT device 1 may be, for example, any device that is capable of connecting to the internet, such as refrigerators, washing machines, televisions and smart devices. Furthermore, the mFinity IoT device 1 may be any device that is capable of connecting to the internet 2 in various fields such as telematics devices, vehicle control devices, security devices, meteorological observation devices, location tracking devices, measuring devices for volume-rate food waste collection system, remote meter reading devices, etc.

For example, the mFinity IoT device 1 may be assigned a unique code using installation programs or SDK (software development kit) that is downloaded and installed, and then the mFinity IoT device 1 may be registered. Furthermore, the mFinity IoT device 1 may generate IoT data in the form of mFinity and then transfer the IoT data to the mFinity IoT web server 3.

Here, the mFinity IoT devices 1 may be authenticated using information pre-registered by developers of mFinity IoT devices.

For example, an mFinity IoT SDK may be available for manufacturers to download and use in order to program within IoT ready devices. The mFinity SDK may provide easy-to-use APIs for the devices.

Here, the mFinity IoT device 1 may mean an IoT device with an mFinity IoT module installed. The mFinity IoT module with the SDK may contain a downloadable agent to be installed to IoT ready devices.

For example, as shown in FIG. 2, an mFinity IoT device 1-1, which is capable of directly connecting to the internet 2, may connect to the internet 2 and transfer data in the form of mFinity to the mFinity big data cloud 4. Meanwhile, an mFinity IoT device 1-2, which is incapable of directly connecting to the internet 2, may indirectly connect to the internet 2 via an mFinity client terminal 6, which is capable of connecting to the internet 2, and transfer data in the form of mFinity to the mFinity big data cloud 4.

In addition, when connected to the internet 2, the mFinity IoT device 1-1, which is capable of directly connecting to the internet 2, may transfer the generated IoT data to the mFinity IoT web server 3. When not connected to the internet 2, the mFinity IoT device 1-1 may store the generated IoT data within the mFinity IoT device 1 such that the data may be transferred to the mFinity IoT web server 3 later.

For example, when the mFinity IoT device 1-1 is constantly connected to the internet, the data generated within the mFinity IoT device 1-1 may be directly transferred to the mFinity IoT web server 6.

However, when the mFinity IoT device 1-1 is not connected to Internet, the data generated within the mFinity IoT device 1-1 may be written within the mFinity IoT device 1-1 and may later be transferred when the mFinity IoT device 1-1 is connected to a phone or a tablet with an mFinity client pre-installed.

Once the data is transferred from the mFinity IoT device 1-1 to an mFinity client, e.g., a phone or a tablet, the mFinity client may upload the IoT data to the mFinity IoT web server.

Here, the mFinity client terminal 6 may be a smartphone, which is capable of connecting through various communicational means to the mFinity IoT device 1-2, which is incapable of connecting to the internet 2. However, the mFinity client terminal 6 is not necessarily limited to a smartphone but may be any device that is capable of connecting to the mFinity IoT device 1-2, e.g., mobile terminals, PDAs, smart pads, laptop computers, personal computers, smart cameras, smart camcorders, e-books, etc. Furthermore, the mFinity client terminal 6 may be a various type of transmitter and receiver for communications such as two-way radios, satellite transmitter and receivers, etc.

For example, the mFinity client, which includes an mFinity EMMP, may include a program that corresponds to an mFinity IoT within a smartphone or a tablet in order to receive data transferred from the mFinity IoT device 1.

Furthermore, as shown in FIGS. 2 and 3, the mFinity big data cloud 4 of a system for operating an IoT analysis service according to an embodiment of the present invention may include the mFinity IoT web server 3, which functions as a gateway 3-1, the Hadoop server, which collects data from distributed data sources, and an mFinity big data administrator console 7, which manages the Hadoop server 5.

Here, the mFinity IoT web server 3 serves as an IoT data collection point for mFinity IoT data transferred directly from the mFinity IoT device 1 or the mFinity client 6. Furthermore, the mFinity IoT web server 3 acts as the gateway to the mFinity big data cloud 4.

Therefore, any unknown data source point will not be accepted by the mFinity IoT web server 3 and will not be transferred to the mFinity big data cloud 4.

Furthermore, the mFinity big data administrator console 7 manages and governs all the details of the mFinity EMMP including the mFinity big data. The mFinity big data administrator console 7 manages all the details of big data related functions.

Therefore, the mFinity big data users do not have to know much about the big data, and a setup related to the Hadoop server 5 may be automated within the mFinity big data administrator console 7.

Here, the mFinity big data cloud 4 includes all components related to the Hadoop sever 5, which are managed and configured by the mFinity big data administrator console 7.

For example, it is important to be noted that all the details of information related to the Hadoop sever 5 are hidden from the user (cloud subscriber including individuals and businesses) so that the user of the mFinity big data cloud 4 does not have to understand or figure out how the Hadoop sever 5, which is related to processors or agents, is specifically set up.

In summary, the IoT data generated by the mFinity IoT devices 1 may be pushed to the mFinity IoT web server 3. Here, the IoT data may be encrypted and the mFinity big data cloud 4 server information may be hidden using mFinity's DataGate method. For example, an account may be created in the mFinity big data cloud 4 and the mFinity IoT device 1 may be registered, and then an mFinity IoT SDK may be downloaded and used in the device program.

Using the mFinity SDK, the mFinity IoT device 1 may be able to easily write the data in the form of a text file or on a mobile database.

Here, a developer of the IoT device does not have to understand what happens after the data is written in the device or transferred to the mFinity IoT web server. The flow of remaining data may be handled by mFinity big data processing.

Accordingly, a system for operating an IoT big data analysis service according to an embodiment of the present invention may determine whether the data transferred through the internet 2 using the mFinity IoT web server 3 from the mFinity IoT device 1 is a known source point, and may store the data in the mFinity big data cloud 4 if the data is determined to be a known source point. Furthermore, the Hadoop server 5, which is a kind of the big data analysis system, may analyze the stored data and produce a big data analysis report.

More particularly, for example, as shown in FIG. 3, a virtual big data marketplace 3-2 where big data in the form of a stored mFinity platform can be purchased or sold may be provided on the mFinity web server 3 of the mFinity big data cloud 4, and the big data purchased or sold at the big data marketplace 3-2 may be transferred to at least one of an mFinity client terminal 6, an individual customer's terminal 10 and a business customer's computer 20.

Additionally, for example, as shown in FIG. 3, a virtual analysis report marketplace 3-3 where information on analyzed big data analysis report can be purchased or sold may be provided on the mFinity IoT web server 3 of the mFinity big data cloud 4, and the information on the big data analysis report purchased or sold at the analysis report marketplace 3-3 may be transferred to at least one of the mFinity client terminal 6, the individual customer's terminal 10 and the business customer's computer 20.

Here, although it has been illustrated that the big data market place 3-2 and the big data analysis report marketplace 3-3 is provided on the mFinity IoT web server 3, the present invention is not limited thereto. The big data market place 3-2 or the big data analysis report marketplace 3-3 may be structured physically or logically within the mFinity big data administrator console 7 or the mFinity big data cloud 4 or at a certain place in the mFinity big data cloud.

Here, the individual customer's terminal 10 may be a terminal of a person or an agency or affiliated store or a group that wishes to receive big data or a preliminary report that analyzed big data or an analysis report using a preliminary report. The individual customer's terminal 10 may be any type of device that can be used by an individual, e.g., user's terminal, PDA, smart pad, smart pad, camera, camcorder, laptop computer, e-book, personal computer, server computer, etc.

Furthermore, the business customer's computer 20 may be a computer of a business that wishes to receive big data or a preliminary report that analyzed big data or an analysis report using a preliminary report. The business customer's computer 20 may be any type of device that can be used by an employee of a business, e.g., terminal, PDA, smartphone, smart pad, camera, camcorder, laptop computer, e-book, personal computer, server computer, etc.

Therefore, the mFinity big data cloud 4 may have a marketplace section for users (or subscribers) as well as non-users (or non-subscribers) to purchase or sell each other's big data.

Furthermore, big data of a subscriber (or user) may be registered with the marketplace of the mFinity big data cloud for unique identification.

Furthermore, the big data generated by using the mFinity big data cloud 4 may include a pre-registered identification code inserted as part of the data.

Here, as big data accumulates in the “cloud/storage” together with the pre-registered unique identification code and can be posted on the “mFinity Big Data Mart” for exchange, sell, or lease. Therefore, a set of big data that is not generated from the mFinity big data cloud may be sold in this marketplace.

To that end, as shown in FIG. 3, a personal IoT big data of a person who purchased an mFinity IoT ready device or the mFinity IoT device 1 may be stored as a personal version in a personal big data place 3-4 of the mFinity IoT web server 3 of the mFinity big data cloud 4. A business's IoT big data that has accumulated for products may be stored as an enterprise version in a business big data place 3-5.

For example, a personal IoT big data may assume that the IoT device is ready for mFinity IoT and an individual consumer may purchase the IoT device for his or her own use.

Here, an owner (consumer owner) of an mFinity IoT ready device may register the IoT device to create a personal big data place within the mFinity big data cloud. And the data generated from each mFinity IoT device 1 may be stored in his or her own big data spaces. The consumer owner may have multiple mFinity IoT ready devices registered within his or her personal big data place 3-4.

Furthermore, the mFinity IoT device 1 may send its data to both the enterprise big data cloud for manufacture and the personal big data cloud for consumer owners. A big data analysis report service may be provided to personal users who have their big data in the mFinity big data cloud 4.

Furthermore, businesses may have their own big data storage or use an mFinity big data cloud service to host their big data.

Furthermore, big data that has accumulated over time may be placed for a third party to use for analyses with or without fees.

Therefore, businesses may perform an analytic review of their big data using their data that has accumulated in the mFinity big data cloud.

Meanwhile, as shown in FIG. 3, the information on big data analysis report may include information on a preliminary analysis report whose results vary according to analysis time or period. When a third party analyzes big data using the information on preliminary analysis report, information on fees for the service may be transferred to the writer's terminal 30 where the information on preliminary analysis report is uploaded to the analysis report marketplace 3-3.

For example, many businesses do not know how meaningful reports are generated from big data. An mFinity big data cloud may have section subscribers and non-subscribers to the mFinity big data cloud, who wish to buy, sell, or lease preliminary big data analysis reports.

In the IoT big data analysis service according to the present embodiment, individuals may be able to post a preliminary analysis report and allow third party users to run it.

Since the big data uses data that has accumulated over a long period of time, even the same analysis report may yield different results if it's run in different time periods. A writher of the big data report may charge fees for each run of the analysis report instead of licensing the code.

Once any meaningful analysis report is produced, the mFinity big data cloud may provide an option to utilize the mFinity EMMP's app deployment method via an mFinity client (smart container box).

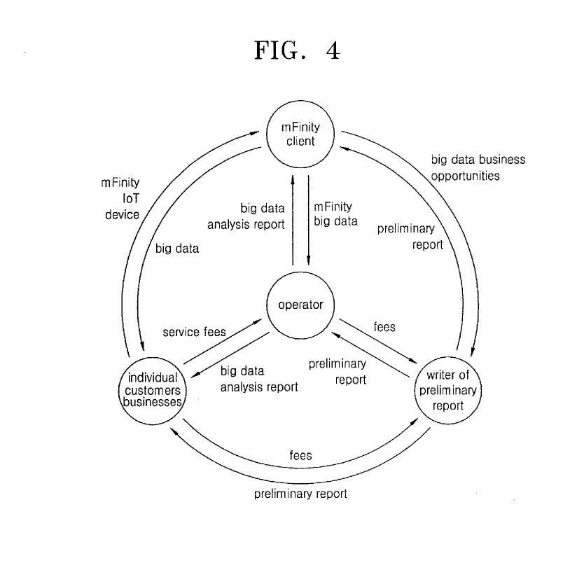

Therefore, as shown in FIG. 4, an mFinity IoT client may transfer data in the form of mFinity platform from the mFinity IoT devices 1 to the mFinity big data cloud 4 and receive big data or a meaningful analysis report. Individual or business customers may easily receive an analysis report of the data they provide or have using a preliminary report. A writer of preliminary reports may charge fees for the preliminary reports. An operator may charge fees for providing an IoT big data analysis service. Accordingly, all parties involved may benefit from this business model.

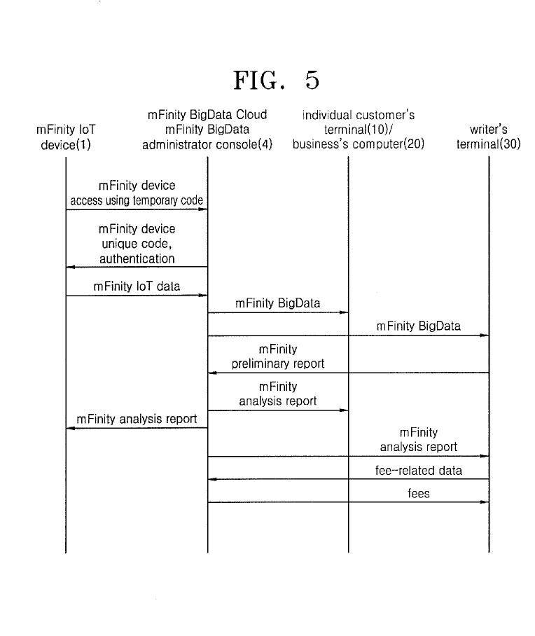

FIG. 5 is a flowchart sequentially illustrating a method for operating an IoT big data analysis service according to an embodiment of the present invention.

A method for operating an IoT big data analysis service according to an embodiment of the present invention will be sequentially described with reference to FIG. 5. First, the mFinity IoT device 1 may access the mFinity big data cloud 4 using a temporary code like a new barcode registration process.

Here, only one registration code will be assigned to one mFinity IoT device 1. Just like a barcode, the same IoT device will have the same mFinity IoT registration code. (A logical barcode for the mFinity IoT device 1 is assigned and each data that is generated from the mFinity IoT device 1 will have the logical barcode as one of the identifier for the data).

Then, once the registered mFinity IoT device 1 connects to the mFinity IoT web server 6 (shown in FIG. 2) of the mFinity big data cloud 4, the mFinity IoT web server 6 verifies whether the registration is valid then the mFinity IoT web server 6 pushes down another unique code, which is different from the registration code, to the mFinity IoT device 1.

After registration is completed, the mFinity IoT device 1 may transfer various data to the mFinity big data cloud 4, and the transferred data may be stored in the form of mFinity big data by the mFinity big data cloud 4.

Here, the Hadoop server 5 (shown in FIG. 3) of the mFinity big data cloud 4 includes many different components that are capable of collecting data from the distributed data sources and writing the data on the distributed file systems.

Furthermore, regarding each data collection point, the output process may be associated with a configuration file that includes a source address (URL or IP Address) or destination address (URL or IP address), connection type, data type, etc. Examples are: Flume agents, Hive, PIG, Sqoop, OOZIE, etc.

Then, the mFinity big data cloud 4 may transfer the mFinity big data to one of the individual customer's terminal 10, the business customer's computer 20, the mFinity IoT device 1 and the writer's terminal 30.

Then, the mFinity big data cloud 4 may receive a preliminary report from the writer's terminal 30 and transfer an analysis report using the preliminary report to one of the individual customer's terminal 10, the business customer's computer 20, the mFinity IoT device 1 and the writer's terminal 30.

Then, the mFinity big data cloud 4 may receive data related to fees from the writer's terminal 30 and transfer information on the fees to the writer's terminal 30.

Meanwhile, as shown in FIG. 3, the mFinity big data administrator console 7 may include a graphic user interface screen 7-1, which may capture required information and create a configuration file system for each Hadoop server 5 related to data input/output.

Here, by using the graphical user interface screen, after collecting appropriate information for the configuration files for the subscriber's (or user's) needs regarding big data, the corresponding processes (flume agent, PIC, Sqoop, HDFS, etc.) may be created in the mFinity Hadoop server. Each process can be configured to have one or more physical servers.

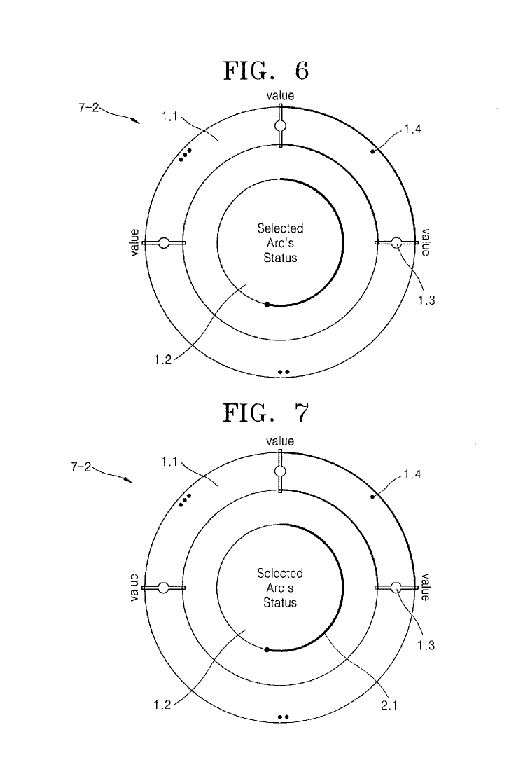

FIGS. 3, 6 and 7 show the graphic user interface screens 7-1 provided by an IoT big data analysis service according to an embodiment of the present invention.

As shown in FIGS. 3, 6 and 7, the graphic user interface screen 7-1 may include a circular control component 7-2. The circular control component 7-2 may include an outer circle 1.1 that is divided into segmented arcs 1.4, which are equivalent to duration, a handler 1.3 that may slides the segmented arcs 1.4 to control the duration and an inner circle 1.2. that is highlighted when the segmented arcs 1.4 are selected and includes a circulator slider 2.1 for controlling the value of the segmented arcs.

For example, the graphical user interface screen 7-1 may comprise a web-based schedule screen application utilizing HTML5, JavaScript, etc.

Here, the graphical user interface screen 7-1 may include a smooth, responsive and screen-sized compatible circular control which includes an outer Circle 1.1 with segmented arcs 1.4, an inner circle 1.2 affixed in the middle, and handlers 1.3.

Furthermore, the segmented arcs 1.4 may include preferred colors, initial values, black circle(s) and the handler 1.3 and may be dynamically added to the outer circle 1.1.

Consequently, the outer circle 1.1 may be divided into segmented arcs 1.4 and every segmented arc 1.4 is equivalent to duration. Furthermore, each arc has a black circle in the center, which corresponds to a segment arc number.

Furthermore, according to the user's preferences, the segmented arcs 1.4 may be adjusted by using the handler 1.3 which displays the corresponding handler value at its top, and adjacent arcs may also be updated while the handler 1.3 of the selected segmented arc 1.4 is slid.

Additionally, the inner circle 1.2 shows the status of the component. When a segmented arc 1.4 is selected, the selected arc may be highlighted with its value shown in the inner circle 1.2 and the inner circle 1.2 may include an adjustable circular slider 2.1 which is used to adjust the value of the selected segment arc 1.4.

While the present invention has been described with reference to embodiments illustrated in the drawings, it will be understood by those of ordinary skill in the art that various changes in form and details may be made without departing from the spirit and scope of the present invention as set forth in the following claims.

Meanwhile, the present invention may be embodied as computer readable codes in a computer readable medium.

A computer readable medium includes any type of recording devices wherein computer readable data can be stored.

Examples of a computer readable medium may include ROMs, RAMs, CD-ROMs, magnetic tapes, floppy disks, magneto-optical disks, optical data storage, flash memory, etc., let alone the above-described cloud. What is embodied as carrier waves (e.g., transfer through the internet) may also be included.

Furthermore, a computer readable medium may be distributed in a networked computer system and computer readable codes may be stored and executed in a distributed manner.

While the present invention has been described with reference to embodiments illustrated in the drawings, it will be understood by those of ordinary skill in the art that various changes in form and details may be made without departing from the spirit and scope of the present invention as set forth in the following claims.

What is claimed is:

1. A method for operating an IoT big data analysis service using a computer system connected to at least one mFinity IoT device through the internet, the method comprising:
determining whether data transferred through the internet using an mFinity IoT web server from the mFinity IoT device is a known source point; and
storing the data in an mFinity big data cloud if the data is determined to be a known source point,
wherein a Hadoop server, which is a big data analysis system, analyzes the stored data and produces a big data analysis report.

2. The method of claim 1,
wherein, if the mFinity IoT device is capable of directly connecting to the internet, the mFinity IoT device connects to the internet and transfers data in the form of mFinity to the mFinity big data cloud, and
wherein, if the mFinity IoT device is incapable of directly connecting to the internet, the mFinity IoT device indirectly connects to the internet via an mFinity client terminal, which is capable of connecting to the internet, and transfers data in the form of mFinity to the mFinity big data cloud.

3. The method of claim 1,
wherein a virtual big data marketplace where big data in the form of a stored mFinity platform can be purchased or sold is provided on the the mFinity big data cloud, and
wherein the big data purchased or sold at the big data marketplace is transferred to at least one of an mFinity client terminal, an individual customer's terminal and a business customer's computer.

4. The method of claim 1,
wherein a virtual analysis report marketplace where information on analyzed big data analysis report can be purchased or sold is provided on the mFinity big data cloud, and
wherein the information on the big data analysis report purchased or sold at the analysis report marketplace is transferred to at least one of an mFinity client terminal, an individual customer's terminal and a business customer's computer.

5. The method of claim 4,
wherein the information on big data analysis report includes information on a preliminary analysis report whose results vary according to analysis time or period,
wherein, when a third party analyzes big data using the information on preliminary analysis report, a writer who uploaded the information on preliminary analysis report to the analysis report marketplace charges fees for the information.

6. The method of claim 1,
wherein the mFinity IoT device is assigned a unique code using SDK that is downloaded and installed, and then the mFinity IoT device is registered and
wherein the mFinity IoT device generates IoT data in the form of mFinity and then transfers the IoT data to the mFinity IoT web server.

7. The method of claim 1,
wherein, if the mFinity IoT device is connected to the internet, the mFinity IoT device transfers data in the form of mFinity to the mFinity IoT web server, and
wherein, if the mFinity IoT device is not connected to the internet, the mFinity IoT device stores the created IoT data within the mFinity IoT device such that the data may be transferred to the mFinity IoT web server later.

8. The method of claim 1,
wherein the mFinity big data cloud includes:
the mFinity IoT web server, which functions as a gateway,
the Hadoop server, which collects data from distributed data sources, and
an mFinity big data administrator console, which manages the Hadoop server.

9. The method of claim 8,
wherein the mFinity big data administrator console includes a graphic user interface screen, and
wherein the graphic user interface screen captures required information and creates a configuration file system for each Hadoop server related to data input/output.

10. The method of claim 9,
wherein the graphic user interface screen includes a circular control component, and
wherein the circular control component includes:
an outer circle that is divided into segmented arcs, which are equivalent to duration,
a handler that slides the segmented arcs to control the duration and
an inner circle that is highlighted when the segmented arcs are selected and includes a circulator slider for controlling the value of the segmented arcs.

11. The method of claim 1,
wherein a personal IoT big data of a person who purchased an mFinity IoT ready device or an mFinity IoT device is stored as a personal version in a personal big data place of the mFinity big data cloud, and
wherein business's IoT big data that has accumulated for products is stored as an enterprise version in a business big data place of the mFinity big data cloud.

12. A system for operating an IoT big data analysis service using a computer system connected to at least one mFinity IoT device through the internet, the system comprising:
a control unit that is programmed to determine whether data transferred through the internet using an mFinity IoT web server from the mFinity IoT device is a known source point; and to store the data in an mFinity big data cloud if the data is determined to be a known source point,
wherein a Hadoop server, which is a big data analysis system, analyzes the stored data and produces a big data analysis report.

13. A computer readable medium on which a method for operating an IoT big data analysis service using a computer system connected to at least one mFinity IoT device through the internet is written, the method comprising:
determining whether data transferred through the internet using an mFinity IoT web server from the mFinity IoT device is a known source point; and
storing the data in an mFinity big data cloud if the data is determined to be a known source point,
wherein a Hadoop server, which is a big data analysis system, analyzes the stored data and produces a big data analysis report.
